(19) United States
(12) Patent Application Publication
(10) Pub. No.: US 2025/0252455 A1
(43) Pub. Date: Aug. 7, 2025

(54) INFORMATION PROCESSING DEVICE AND INFORMATION PROCESSING METHOD FOR IN-STORE SALES PROMOTION

(71) Applicant: Toshiba Tec Kabushiki Kaisha, Tokyo (JP)

(72) Inventor: Kazuhiro ODOKO, Izunokuni Shizuoka (JP)

(21) Appl. No.: 18/940,230

(22) Filed: Nov. 7, 2024

(30) Foreign Application Priority Data
Feb. 1, 2024 (JP) 2024-013861

(51) Int. Cl. G06Q 30/0207; G06Q 30/0251

(52) U.S. Cl. CPC G06Q 30/0224; G06Q 30/0252

(57) ABSTRACT

According to one embodiment, an information processing device for in-store sales promotion generation includes a processor and a communication interface connectable to an input device. The processor receives current environment information indicating a state of a store environment and customer information related to a customer in the store. The processor converts the received current environment information and customer information to text describing at least portions of the current environment information and the customer information, then converts the text to an input sentence for a generative artificial intelligence model, which is then input to the generative artificial intelligence model to acquire a sales promotion sentence suggesting a merchandise item corresponding to the current environment information and the customer information. Additional merchandise information related to the suggested merchandise item can be acquired and the sales promotion sentence and the acquired merchandise information can then be output to the customer.

### CROSS-REFERENCE TO RELATED APPLICATION

This application is based upon and claims the benefit of priority from Japanese Patent Application No. 2024-013861, filed Feb. 1, 2024, the entire contents of which are incorporated herein by reference.

### FIELD

Embodiments described herein relate generally to an information processing device and an information processing method for providing in-store sales promotions.

### BACKGROUND

Recently, techniques for automatically generating a response to a prompt by using an AI model called a large language model (LLM) have been proposed. A large language model is an AI model trained on a large corpus in the field of natural language processing and is functionalized in such a way that when a text inquiry is along inputted with response (output) format information (also referred to as a prompt), a text answer corresponding to the inquiry content is generated and output in the desired format.

In a store, such as a restaurant or a supermarket, particular items such as a menu item or a type of merchandise may be electronically recommended to a customer for sales promotion.

For example, in the related art, a technique of generating the content for a sales promotion based on weather data (acquired from an external server or otherwise) in conjunction with an attribute of the viewer viewing digital signage has been proposed. However, in the related art, the content for the sales promotion is generated from a preset list of target merchandise items for sales promotion and therefore lacks flexibility.

### BRIEF DESCRIPTION OF THE DRAWINGS

FIG. 1 depicts a schematic configuration of an information processing system according to an embodiment.

FIG. 2 is a block diagram of an information processing device.

FIG. 3 is a block diagram depicting functional aspects of an image processing device according to an embodiment.

FIG. 4 shows an example of a sales promotion sentence.

FIG. 5 is a flowchart of control processing according to an embodiment.

### DETAILED DESCRIPTION

An embodiment described provides an information processing device and an information processing method that enables more flexible and an improved implementation of in-store sales promotion activities or the like.

In general, according to one embodiment, an information processing device includes a processor and a communication interface connectable to an input device. The processor is configured to: receive current environment information related to a state of a store environment of a store; receive customer information about a customer in the store; convert the received current environment information and customer information to text describing at least portions of the current environment information and the customer information; convert the text to an input sentence for a generative artificial intelligence model; input the input sentence to the generative artificial intelligence model to acquire a sale promotion sentence suggesting a merchandise item corresponding to the current environment information and the customer information; acquire merchandise information related to the suggested merchandise item; and output the sale promotion sentence and the acquired merchandise information to the customer in the store.

An example embodiment of an information processing system will now be described with reference to the drawings. The embodiments described below do not limit the present disclosure. Moreover, various omissions, replacements, changes, substitutions, and combinations of component elements can be made without departing from the scope of the present disclosure.

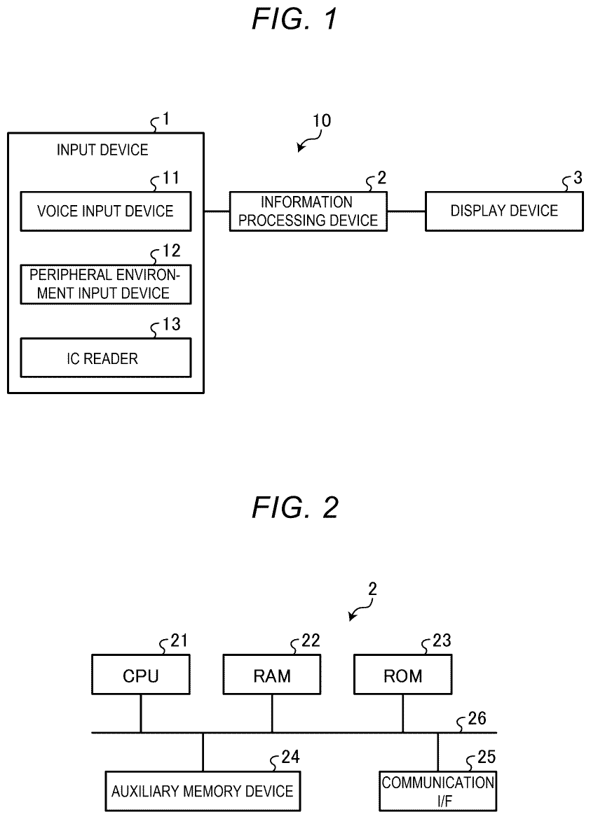

FIG. 1 provides a schematic configuration of an information processing system 10 according to an embodiment. The information processing system 10 has an input device 1, an information processing device 2, and a display device 3. The input device 1 has a voice input device 11, a peripheral environment input device 12, and an IC reader 13. An example in which the information processing system 10 is applied in a restaurant will be described as one embodiment.

The voice input device 11 is, for example, a microphone to receive voice input from a customer or potential customer at the restaurant. The voice input device 11 acquires voice data from the customer and outputs the acquired voice data to the information processing device 2. The voice data may include the conversation of the customer while present in the restaurant.

The peripheral environment input device 12 receives or provides information about the current ambient environment in the restaurant. The peripheral environment input device 12 is or comprises, for example, a camera, a thermometer, a hygrometer or the like. The camera provides image data and/or an image of the customer or the surroundings of the customer. An acquired image may depict the customer eating a menu item served by the restaurant. The input device 1 outputs the image data (referred to here as picked-up image data) to the information processing device 2. The picked-up image data provides, for example, an image of the face of the customer and/or a way to evaluate the progress of the customer in eating an already served menu item. For example, the image data may show that a menu item has been finished by the customer, partially eaten, or uneaten.

The thermometer acquires temperature data (e.g., a temperature level) in the restaurant or outside the restaurant and outputs the acquired temperature data to the information processing device 2. The hygrometer acquires humidity data (e.g., a humidity level) of the place in the restaurant or outside the restaurant and outputs the acquired humidity data to the information processing device 2. In the following, any data output by the input device 1 including at least one of the voice data, the picked-up image data, the temperature data, and the humidity data is collectively to referred as peripheral environment information.

The IC (integrated circuit) reader 13 is a device that can identify the customer present in the restaurant. The IC reader 13 acquires, for example, customer information from an IC card of the customer, and outputs the acquired customer information to the information processing device 2. In this context, customer information includes at least an identification number identifying the customer. The identification number may be associated with the customer's past transaction information related to prior transaction in the store/restaurant.

An input device 1 may be provided at each seat (or table) in the restaurant. The input device 1 may be provided as a tablet terminal at each table or may be an order acceptance terminal that is used to receive (input) an order for a menu item from the customer. Multiple thermometers and hygrometers may be provided inside the restaurant and/or outside the restaurant. Or a single thermometer and/or hygrometer may be provided for multiple input devices 1.

The information processing device 2 is, for example, a store server or a company server device managed by an operating company that operates the restaurant. Also, in this embodiment, the information processing device 2 is a computer having generative AI model, such as a large language model (LLM), that automatically generates text. In this example, the large language model generates a sales promotion sentence for promoting a merchandise item or a menu item. In some examples, the large language model may generate an input sentence (a prompt) for generating a sales promotion sentence. The sales promotion sentence is then provided to the customer at the store. The information processing device 2 may be one computer or a plurality of computers working in conjunction.

The information processing device 2 supports a sales promotion effort for a merchandise item (or a menu item) available for sale at the store based on various information acquired via the input device 1. The information processing device 2 may be connected to the input device 1, for example, via a fixed communication line, a wireless network, or a cellular network. The information processing device 2 is also connected to the display device 3 via a fixed communication line, a wireless network, or a cellular network.

The display device 3 is provided at the restaurant to provide information to a customer in the store. The display device 3 may comprise one computer or a plurality of computers. The display device 3 may be provided primarily for the customer to review the menu item served by the restaurant or to permit the customer to place (via operation of the display device 3). When an input device 1 is installed at each table, the input device 1 and the display device 3 may be implemented together as, or incorporating, the same terminal device.

A hardware configuration the of information processing device 2 will now be described with reference to FIG. 2. FIG. 2 is a block diagram of the information processing device 2 according to an embodiment. As shown in FIG. 2, the information processing device 2 has a central processing unit (CPU) 21, a random-access memory (RAM) 22, a read-only memory (ROM) 23, an auxiliary memory device 24, and a communication interface (I/F) 25.

The CPU 21 is a control entity. A program and various data may be loaded into the RAM 22. The ROM 23 stores various programs. The auxiliary memory device 24 stores various programs and data. The communication I/F 25 is an interface for data communication to the input device 1 and the display device 3.

The CPU 21, the RAM 22, the ROM 23, the auxiliary memory device 24, and the communication I/F 25 are connected to each other via a bus 26. The CPU 21, the RAM 22, and the ROM 23 may be considered to form a control unit or a controller. The control unit executes control processing of the information processing device 2 by causing the CPU 21 to operate according to a control program stored in the ROM 23 or the auxiliary memory device 24 and then loaded in the RAM 22.

The auxiliary memory device 24 can be a nonvolatile memory such as a hard disk drive (HDD) or a flash memory, in which stored information is held even when the power is turned off. The auxiliary memory device 24 stores merchandise information about merchandise items provided at the store, the peripheral environment information and the customer information acquired from the input device 1, text information acquired by the information processing device 2, and the input sentence and the sales promotion sentence generated by the information processing device 2.

It is generally preferable that the information processing device 2 is installed in a secure environment. The secure environment may be the local environment in the restaurant or the like where the information processing device 2 is to be used rather than an open environment. Since the auxiliary memory device 24 may store confidential information such as customer information, the voice data associated with the conversations of the customer, and the picked-up image data of the customer, limiting the information processing device 2 to a local network environment or the like helps the protection of personal or confidential information.

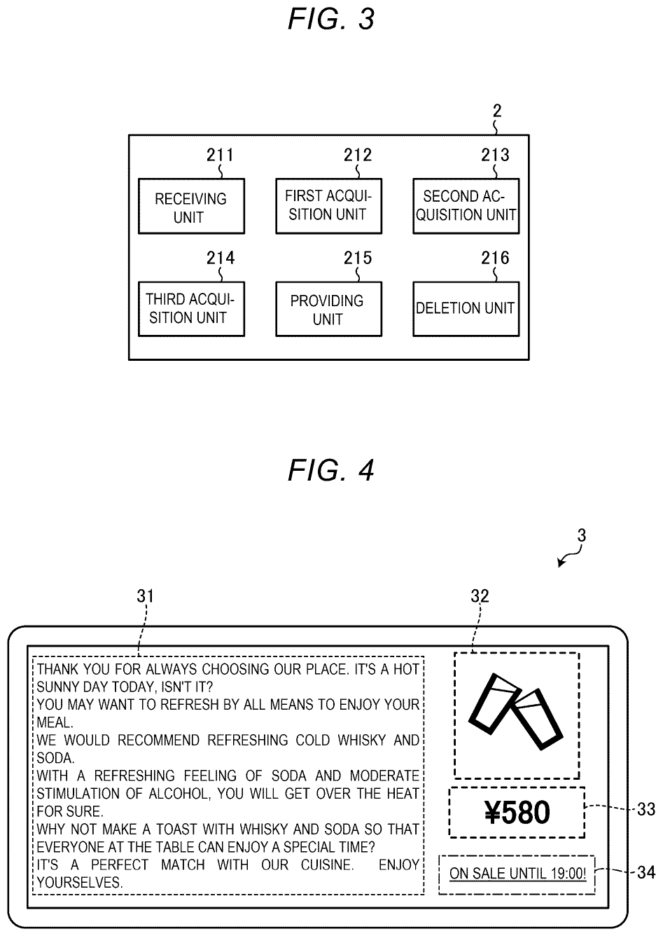

FIG. 3 is a block diagram showing an example of the functional aspects of the information processing device 2 according to an embodiment. As shown in FIG. 3, the information processing device 2 provides a receiving unit 211, a first acquisition unit 212, a second acquisition unit 213, a third acquisition unit 214, a providing unit 215, and a deletion unit 216. However, the functional aspects of the information processing device 2 is not limited to this.

The receiving unit 211 receives the peripheral environment information and the customer information. Specifically, the receiving unit 211 receives the peripheral environment information about the peripheral environment in the store and the customer information about a customer present in the store, output from the input device 1. The receiving unit 211 then stores the peripheral environment information and the customer information in the auxiliary memory device 24.

The first acquisition unit 212 acquires text information (text) related to the current state of the store (as represented by the received peripheral environment information) and the customer (as represented by the received customer information).

For example, the first acquisition unit 212 performs voice recognition processing, natural language processing (NLP), image recognition processing or the like on the peripheral environment information and/or the customer information by a known technique, thus generates or acquires text expressing the state corresponding to the peripheral environment information and the customer information. The first acquisition unit 212 also stores the acquired text in the auxiliary memory device 24.

The second acquisition unit 213 cooperates with a large language model. Specifically, the second acquisition unit 213 generates and then inputs a prompt (corresponding to the text information and format information to the large language model (LLM) by a known technique to generate an input sentence related to the state of the customer and the store.

The second acquisition unit 213 then acquires the input sentence that was generated by the large language model. The second acquisition unit 213 stores the acquired input sentence in the auxiliary memory device 24. The input sentence includes information related to at least the state of the customer, the state of the peripheral environment, and the store (restaurant). The information related to the store is referred to as store information and can be, for example, information about the menu items that can be served to the customer at the store.

The second acquisition unit 213 generates a first prompt relating, for example, to a menu item ordered by the customer by voice command. The voice command may be extracted from the voice data and translated to text, or the like. Information regarding the state of the customer may relate to the menu item(s) ordered by the customer.

The second acquisition unit 213 also generates a second prompt relating, for example, to the temperature included in the temperature data, the humidity included in the humidity data, and/or an estimated age and gender of the customer, the number of people seated at the table with the customer or in the store overall, the state of the face of the customer (for example, sweating or the like), and the progress of the customer's meal or the eating of a particular menu item. The state of the face, meal progress, and other information may be extracted or otherwise provided by an acquired image.

The second acquisition unit 213 also generates a third prompt relating, for example, to menu items at the restaurant and known or estimated information about the user's preferences from the past transaction information included in customer information.

The second acquisition unit 213 also acquires a sales promotion sentence corresponding to the state of the store and the customer from a large language model functionalized to generate a sales promotion sentence for merchandise items. Specifically, the second acquisition unit 213 inputs the acquired input sentence to the large language model and thus acquires a sales promotion sentence for a merchandise item.

The second acquisition unit 213 inputs the acquired input sentence along with the format information requesting the generation of a sales promotion sentence for a merchandise item to the large language model, and acquires a sales promotion sentence as generated by the large language model. The sales promotion sentence includes mention of at least a merchandise or menu item to be recommended to the customer and a sales promotion associated with the merchandise item.

For example, the second acquisition unit 213 inputs the input sentence and the format information to the large language model by a known technique, and thus causes the large language model to generate a sales promotion sentence and acquires the sales promotion sentence from the large language model.

The second acquisition unit 213 generates a fourth prompt relating, for example, to server instructions, which results in a sales promotion sentence such as, “This is a restaurant. You are a waitress. Promote the sales of a merchandise item to your customer. Suggest that the customer place an additional order of whisky and soda.” or the like. The second acquisition unit 213 stores the acquired sales promotion sentence in the auxiliary memory device 24. As the first prompt, the second prompt, the third prompt, and/or the fourth prompt, prompts prepared in advance (preset prompts) in the auxiliary memory device 24 may be used or the second acquisition unit 213 may dynamically generate these prompts.

The third acquisition unit 214 acquires merchandise information related to any merchandise item mentioned in the sales promotion sentence. The merchandise information is, for example, a menu item image, a menu item price, and special notes about the merchandise item. The special notes can be information about limited-time sale related to the item or other promotional information. The third acquisition unit 214 stores the acquired merchandise information and the sales promotion sentence in correlation with each other in the auxiliary memory device 24.

The providing unit 215 provides the sales promotion sentence to the customer. Specifically, the providing unit 215 provides the sales promotion sentence (acquired by the second acquisition unit 213) to the customer via the display device 3. The providing unit 215 provides the sales promotion sentence along with the related merchandise information to the customer. Specifically, the providing unit 215 provides the sales promotion sentence acquired by the second acquisition unit 213 along with the merchandise information acquired by the third acquisition unit 214 to the customer via the display device 3.

FIG. 4 is a schematic view showing an example of a sales promotion sentence according to an embodiment. FIG. 4 depicts the display device 3 showing a message 31 corresponding to the sales promotion sentence along with a menu item image 32, a menu item price 33, and special notes 34 matching the merchandise information. FIG. 4 shows the menu item image 32, the menu item price 33, and the special notes 34 corresponding to a “whisky and soda” merchandise item. References to the merchandise item (“whisky and soda”) are also included in the message 31.

The customer can review the sales promotion sentence on the display device 3 and thus can grasp the intended information about product/item recommendations.

The information processing device 2 acquires the changes in the circumstances of the customer and the peripheral environment in real time and therefore can update information corresponding to a change in the circumstance. By this system, the restaurant can automatically make suggestions to the customer via the display device 3 and therefore may increase orders and spending per customer.

Referring back to FIG. 3, the deletion unit 216 deletes the peripheral environment information, the customer information, the text information, the input sentence, the sales promotion sentence, and the merchandise information after the customer performs settlement processing. This deletion process is because the relevant information varies from one customer to another and therefore is no longer necessary once the customer performs settlement processing and exits the store. Thus, the information processing device 2 can also reduce the risk of leakage of confidential information.

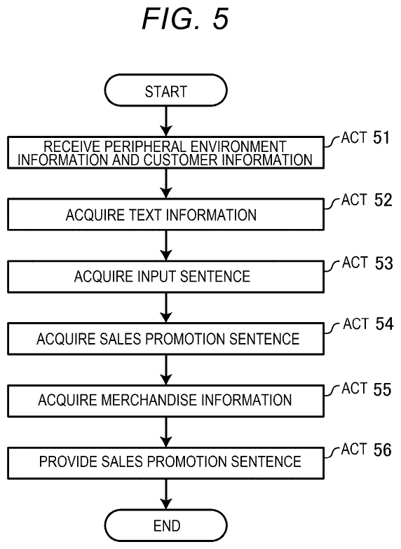

The control processing of the information processing device 2 will now be described with reference to FIG. 5. FIG. 5 is a flowchart showing an example of the control processing of the information processing device 2 according to an embodiment.

The receiving unit 211 receives the peripheral environment information and the customer information (ACT 51). Next, the first acquisition unit 212 acquires text information based on the peripheral environment information and the customer information (ACT 52).

Next, the second acquisition unit 213 cooperates with a large language model to acquire an input sentence corresponding to the state of the store and the customer (as represented by the text information) (ACT 53). The second acquisition unit 213 inputs the input sentence to the large language model and acquires a sales promotion sentence corresponding to state of the store and the customer from a large language model functionalized to generate a sales promotion sentence related to a merchandise item and the state of the store and the customer (ACT 54).

The third acquisition unit 214 acquires merchandise information related to the merchandise item mentioned in the sales promotion sentence from the auxiliary memory device 24 (ACT 55). The providing unit 215 then provides the sales promotion sentence to the customer via the display device 3 (ACT 56). The providing unit 215 also provides the relevant merchandise information to the customer. Thus, the customer can review the sales promotion sentence shown on the display device 3.

As described above, the information processing device 2 according to an embodiment receives peripheral environment information and customer information, acquires text information (text) indicating a state of the store and the customer (as represented by the peripheral environment information and the customer information), inputs this text information into a large language model functionalized to generate a sales promotion sentence for a merchandise item corresponding to the state of the store and the customer, and then provides the acquired sales promotion sentence to the customer.

Thus, the information processing device 2 can provide a flexible sales promotion sentence to the customer by using the peripheral environment in the store and the customer information about the customer. Thus, a store such as a restaurant or a supermarket can flexibly implement sales promotion activities for sales promotions for merchandise items.

The above embodiment can be implemented with a suitable modification by changing a part of the configurations or functions of each of the above devices. In the description below, some modification examples are described as other embodiments. In the description below, differences from the above embodiment are mainly described and the same matters as the already described are not described again in detail. The modification examples described below may be implemented separately or may be combined with one another where appropriate.

### First Modification Example

In an embodiment, the display device 3 is installed at a restaurant. However, this is not limiting. For example, the display device 3 may be a portable terminal provided by the store to a customer for use at the store. For example, the display device 3 may be part of a supermarket system including a shopping cart mounted terminal or the like.

Also, in the input device 1 of the information processing system 10, the voice input device 11 may be omitted.

The portable terminal incorporating or providing the display device can be a portable terminal device such as a smartphone owned by the customer. For example, a dedicated shopping application for merchandise registration and payment processing in the store may be installed in the portable terminal so the portable terminal may be used for shopping in the store.

The information processing device 2 in the first modification example acquires the peripheral environment information outputted from the peripheral environment input device 12 and the text information outputted from the customer information outputted from the IC reader 13.

### Second Modification Example

In an embodiment, the information processing device 2 provides a large language model and is configured to be used in a local environment. However, this is not limiting. The information processing device 2 may be configured to be used in a high-security cloud environment. In general, a high-security cloud environment can be a cloud-based computing environment that is not made publicly accessible over the internet and is connected to an in-house server environment via a private or dedicated communication line for high confidentiality.

### Third Modification Example

The peripheral environment information about the peripheral environment in the store and the customer information about the customer present in the store, received by the receiving unit 211 of the information processing device 2 may include confidential information. The confidential information can be, for example, identifying or identifiable customer information, non-public or sensitive information elements such as the name, telephone number, and email address of the customer, or the business name of the company which the customer belongs to.

In such a case, the first acquisition unit 212 of the information processing device 2 may acquire text information in the form of a text expressing the state of the store and the customer represented by the peripheral environment information and the customer information, excluding any element meeting a predetermined condition indicating the element concerns sensitive or confidential information not to be mentioned in the sales promotion effort. The first acquisition unit 212 stores the text information excluding the element(s) satisfying the predetermined condition indicating confidential information in the auxiliary memory device 24.

### Fourth Modification Example

The display device 3 may have a speaker that outputs a voice or sound. By having the speaker, the display device 3 can output a voice or sound corresponding to a sales promotion sentence.

A program executed by the information processing device 2 according to an embodiment may be configured to be stored in a computer connected to a network such as the internet and then downloaded via the network and thus provided. Also, a program executed by the information processing device 2 may be configured to be provided or distributed via a network such as the internet.

A program executed by each device in the above embodiments may be incorporated in advance in a ROM, an auxiliary memory unit, or the like. The program(s) may be recorded as a file in an installable format or an executable format in a non-transitory, computer-readable recording medium such as a CD-ROM, a flexible disk (FD), a CD-R, or a digital versatile disk (DVD).

Also, the program executed by each device in the above embodiment may be configured to be stored in a computer connected to a network such as the internet and then downloaded via the network and thus provided. Also, the program executed by each device in the above embodiment may be configured to be provided or distributed via a network such as the internet.

While an embodiment of the present disclosure has been described, this embodiment has been presented by way of example only, and is not intended to limit the scope of the disclosure. Indeed, the novel embodiments and the modifications thereof described herein may be embodied in a variety of other forms; furthermore, various omissions, substitutions, changes, and combinations in the form of the embodiments described herein may be made without departing from the spirit of the disclosure. The accompanying claims and their equivalents are intended to cover the embodiments or the modifications thereof as would fall within the scope and spirit of the disclosure.

What is claimed is:

1. An information processing device, comprising:
a communication interface connectable to an input device; and
a processor configured to:
receive current environment information related to a state of a store environment of a store;
receive customer information about a customer in the store;
convert the received current environment information and customer information to text describing at least portions of the current environment information and the customer information;
convert the text to an input sentence for a generative artificial intelligence model;
input the input sentence to the generative artificial intelligence model to acquire a sale sentence suggesting a merchandise item corresponding to the current environment information and the customer information;
acquire merchandise information related to the suggested merchandise item; and
output the sale promotion sentence and the acquired merchandise information to the customer in the store.

2. The information processing device according to claim 1, wherein the current environment information includes voice data from a conversation of the customer in the store.

3. The information processing device according to claim 1, wherein the current environment information includes at least one of temperature data and humidity data.

4. The information processing device according to claim 3, wherein the temperature data indicates an in-store temperature.

5. The information processing device according to claim 1, wherein the customer information includes a customer ID read by an integrated circuit chip reader.

6. The information processing device according to claim 5, wherein the customer information includes a past transaction history associated with the customer ID.

7. The information processing device according to claim 1, wherein the generative artificial intelligence model is a large language model functionalized to generate sale promotion sentences only for merchandise items sold by the store.

8. The information processing device according to claim 1, wherein the processor is further configured to:
delete the current environment information, the customer information, the input sentence, the sale promotion sentence, and the merchandise information after the customer performs settlement processing.

9. An in-store sales promotion electronic system, comprising:
a first input device to provide current environment related to a state of a store environment of a store;
a second input device to provide customer information about a customer in the store;
a display device to provide information to the customer in the store; and
a store server including:
a communication interface connected to the first input device and the second input device; and
a processor configured to:
receive current environment information related to a state of a store environment of the store from the first input device;
receive customer information about the customer in the store from the second input device;
convert the received current environment information and customer information to text describing at least portions of the current environment information and the customer information;
convert the text to an input sentence for a generative artificial intelligence model;
input the input sentence to the generative artificial intelligence model to acquire a sale promotion sentence suggesting a merchandise item corresponding to the current environment information and the customer information;
acquire merchandise information related to the suggested merchandise item; and
output the sale promotion sentence and the acquired merchandise information to the display device.

10. The in-store sales promotion electronic system according to claim 9, wherein the current environment information includes voice data from a conversation of the customer in the store.

11. The in-store sales promotion electronic system according to claim 9, wherein the generative artificial intelligence model is a large language model functionalized to generate sale promotion sentences only for merchandise items sold by the store.

12. The in-store sales promotion electronic system according to claim 9, wherein the processor is further configured to:
delete the current environment information, the customer information, the input sentence, the sale promotion sentence, and the merchandise information after the customer performs settlement processing.

13. An information processing method, comprising:
receiving current environment information related to a state of a store environment of a store from an input device via a communication interface;
receiving customer information about a customer in the store;
converting the received current environment information and customer information to text describing at least portions of the current environment information and the customer information;
converting the text to an input sentence for a generative artificial intelligence model;
inputting the input sentence to the generative artificial intelligence model to acquire a sale promotion sentence suggesting a merchandise item corresponding to the current environment information and the customer information;
acquiring merchandise information related to the suggested merchandise item; and
outputting the sale promotion sentence and the acquired merchandise information to the customer in the store.

14. The information processing method according to claim 13, wherein the current environment information includes voice data from a conversation of the customer in the store.

15. The information processing method according to claim 13, wherein the current environment information includes at least one of temperature data and humidity data.

16. The information processing method according to claim 15, wherein the temperature data indicates an in-store temperature.

17. The information processing method according to claim 13, wherein the customer information includes a customer ID read by an integrated circuit chip reader.

18. The information processing method according to claim 17, wherein the customer information includes a past transaction history associated with the customer ID.

19. The information processing method according to claim 13, wherein the generative artificial intelligence model is a large language model functionalized to generate sale promotion sentences only for merchandise items sold by the store.

20. The information processing method according to claim 13, further comprising:
deleting the current environment information, the customer information, the input sentence, the sale promotion sentence, and the merchandise information after the customer performs settlement processing.
